(19) United States
(12) Patent Application Publication
(10) Pub. No.: US 2007/0161345 A1
(43) Pub. Date: Jul. 12, 2007

(54) Vent assembly

(75) Inventor: John D. Chato, Burnaby (CA)

Correspondence Address: MCCARTHY TETRAULT LLP, BOX 48, SUITE 4700,, 66WELLINGTON STREET WEST, TORONTO, ON, M5K 1E6, CA

(73) Assignee: Copia Ventures Limited

(21) Appl. No.: 11/314,095

(22) Filed: Dec. 22, 2005

(51) Int. Cl. E06B 7/02

(52) U.S. Cl. 454/196; 454/195

(57) ABSTRACT

A vent or baffle assembly may be used between the edge of a window and the edge of a recess along which the window can reciprocate, or may be used adjacent a doorway. The vent assembly may include longitudinally extending members, and spacing members, or blocks. The longitudinally extending members and the blocks may be assembly to form a unit having a tortuous internal passageway. The longitudinally extending members may provide structural sturdiness. Sound deadening materials may be applied along a portion or all of the passageway. The longitudinally extending members may be of the same profile, and may nest together in a symmetrical fashion.

### FIELD OF THE INVENTION

This Application relates to the filed of vents, and, in particular, to air vents.

### BACKGROUND OF THE INVENTION

This description relates to air vents such as may be used, for example, in conjunction with windows or adjacent to doors, and such as may tend to permit circulation of air while discouraging or attenuating transmission of sound to some extent.

While sound deadening air passages are known, they may tend to involve relatively complicated assemblies whose manufacturing or installation features may be such as to discourage their actual use. It may be that a user may prefer a vent or baffle assembly for insertion in a window space, or adjacent to a doorway, in which the vent assembly or baffle has an internal convoluted pathway such as may tend to discourage or attenuate the transmission of sound waves, or, as described herein, which may have a lining that may have appropriate acoustical properties for absorbing sound, to some extent, while continuing to permit the passage of air. The various components may be such that different degrees of air entry and sound stoppage may be attained by rotating the vent assembly or baffle through a predetermined angle and inserting it in its rotated condition. Certain component dimensions can also be chosen from a range of aspect ratios to achieve different degrees of restriction of air or sound, or both. It may be that installation may be simplified, as described herein, by providing a passageway of fixed geometry, rather than permitting a user to de-tune the device by altering the passage width. It may also be that, as discussed herein, any one or more of manufacture, sale, installation, maintenance or repair may be facilitated by supplying components in a relatively simple assembly, or in a kit form.

### SUMMARY OF THE INVENTION

In a first aspect of the invention, there is a vent. The vent has first and second longitudinally extending members, and an array of spacing governors. The first and second members are mutually locatable in opposition to each other to define an air passageway therebetween, to permit airflow between the first and second members in a direction cross-wise relative to their longitudinal extent. The spacing governors being mounted to retain the first and second members in a fixed position relative to each other. The air passageway has deviations, the deviations having angles, a sum of the angles being at least as great as 180 degrees. The air passageway has an inlet, an outlet, a path length measured between the inlet and the outlet, and a mean path depth between the first and second members cross-wise to the path length. The path length being at least 8 times as great as the mean path depth. That aspect of the invention may be in the form of a kit prior to assembly.

In a feature of that aspect of the invention, the first and second members have the same cross-sectional profile. In another feature, the first and second members are substantially the same. In a further feature, the vent has a screen mounted thereto athwart the air passageway. In still another feature, the vent has a closure member mounted thereto, the closure member being movable to a position impeding flow through the air passageway. In a still further feature, at least one of the first and second members includes a lining mounted to a substantially rigid member. In yet another feature, the first and second members are channel members and acoustic linings are mounted inside the channel members. In another feature, the channel members have the same cross-section, and each channel section has one leg shorter than another.

In another feature, of that aspect of the invention, the first and second longitudinally extending members are structural sections. The structural sections have substantially the same cross-sectional profile. The structural sections each have a back, a first leg and a second leg, the first and second legs extending away from the back, the second leg being shorter than the first leg. The first and second members, when assembled, are positioned with the second leg of the first longitudinally extending member located between the first and second legs of the second longitudinally extending member, and the second leg of the second longitudinally extending member located between the first and second legs of the first longitudinally extending member. The first and second longitudinally extending members having respective first and second ends; the array of spacing governors include a first end cap and a second end cap. The first end cap is mountable to the first ends of the first and second members and defining a side wall of the passageway. The second end cap is mountable to the second ends of the first and second longitudinally extending members. The air passageway has at least one pair of reverse bends. At least one of the first and second members includes an acoustic attenuation lining mounted to a substantially rigid member.

In an additional feature, each of the structural sections is a channel section, and each of the channel sections has a sound deadening lining mounted to each of the back, the first leg, and the second leg. In another additional feature, each of the structural sections is a channel section, and each of the channel sections has a sound deadening lining mounted therein, each of the linings itself being channel shaped to seat within its respective channel. In still another feature the sound deadening linings are fabricated within the channel sections, and the channel sections define at least a portion of a containment form during the fabrication of the sound deadening linings. These features may be part of a kit supplied for subsequent assembly. In yet another feature, the passageway defined between the first and second structural members has an intake portion, a first bend, a middle portion, a second bend, and an outlet portion, and the passage.

In another aspect of the invention, there is a vent. The vent has a pair of first and second longitudinally extending channel sections of substantially the same cross-sectional profile, each of the channel sections having first and second ends. The first and second channel sections are mutually locatable to define a tortuous air passageway therebetween. The vent may include a pair of first and second spacing fittings, those fittings, on assembly, being co-operable with the first and second channel members to maintain the first and second channel members in a fixed, spaced apart condition. The first spacing fitting are engageable with the first ends of the first and second longitudinally extending channel sections. The second spacing fitting being engageable with the second ends of the longitudinally extending channel sections. The vent may include a sound deadening lining, the sound deadening lining being mountable within the channel sections along the passageway. When the vent is assembled, the passageway includes an inlet, a first portion, a first bend, a second portion, a second bend, a third portion and an outlet. The first bend has an angle of at least 90 degrees. The second bend having an angle of at least 90 degrees. The first and second bends define a reversing chicane. The passageway has a path length L. The passageway has a mean passage depth, h. The path length L being at least 8 times as great as the mean passage depth, h.

In another feature of that aspect of the invention, the channel sections each have a long leg and a short leg. When assembled, the short leg of the first channel section nests between the long leg and the short leg of the second channel section, and the short leg of the second channel section nests between the long leg and the short leg of the first channel section. In another feature, the vent is supplied in a kit form for assembly by a purchaser. In still another feature, the vent is combined with a window, the vent being mounted with the channels in a predominantly horizontal orientation. In still yet another feature, the vent is combined with a doorway, the vent being mounted adjacent to a door, and the channels being oriented in a predominantly upstanding orientation.

In another aspect, the spacing members and the frame members are all composed of sound-absorbent material. In still another aspect, there are sound deadening materials, and the structural members form mold walls against which the sound absorbent material is formed.

These and other aspects and features of the invention may be understood with reference to the description which follows, and with the aid of the illustrations of a number of examples.

### BRIEF DESCRIPTION OF THE FIGURES

The description is accompanied by a set of illustrative Figures in which:

FIG. 1 is an exploded isometric view of an embodiment of vent assembly such as may incorporate one or more aspects of the present invention;

FIG. 2a is an elevation of a window installation of the vent assembly of FIG. 1;

FIG. 2b shows a door installation of a vent assembly such as that of FIG. 1;

FIG. 2c shows a side view of a casement window installation for a vent assembly such as that of FIG. 1;

FIG. 2d shows a front view of the installation of FIG. 2c;

FIG. 2e shows a wall mounted installation of the vent assembly of FIG. 1;

FIG. 3a shows a cross-sectional view of the assembly of FIG. 1 at an end cap, when assembled;

FIG. 3b is a cross-sectional view of two members of the vent assembly of FIG. 1;

FIG. 3c is a cross-sectional view of a mating member of the vent assembly of FIG. 1 for co-operation with the two members of FIG. 3b;

FIG. 3d shows a side view of an alternate end cap for the vent assembly of FIG. 1;

FIG. 3e shows a plan view of the end cap as viewed on arrow ‘3e’ of FIG. 3d;

FIG. 3f shows an isometric view of a spacing block suitable for use with the vent assembly of FIG. 1a;

FIG. 3g shows a cross-section of an alternate embodiment of vent assembly to that of FIG. 1;

FIG. 4a shows an exploded perspective view of an alternate vent assembly to that of FIG. 1;

FIG. 4b shows an enlarged detail of an end of one of the members of the vent assembly of FIG. 4a;

FIG. 5a shows another alternate vent assembly to the vent assembly of FIG. 1;

FIG. 5b shows an exploded perspective view of the vent assembly of FIG. 5a;

FIG. 5c shows a cross-section of the vent assembly of FIG. 5a;

FIG. 5d shows a cross-section of an alternate embodiment of the vent assembly of FIG. 5a;

FIG. 5e shows a cross-section of another alternate embodiment of the vent assembly of FIG. 5a; and

FIG. 6 shows a cross-section of an alternate vent assembly to that of FIG. 1.

### DETAILED DESCRIPTION

The description that follows, and the embodiments described therein, are provided by way of illustration of an example, or examples, of particular embodiments of the principles of aspects of the present invention. These examples are provided for the purposes of explanation, and not of limitation, of those principles and of the invention. In the description, like parts are marked throughout the specification and the drawings with the same respective reference numerals. The drawings are not necessarily to scale and in some instances proportions may have been exaggerated in order more clearly to depict certain features of the invention.

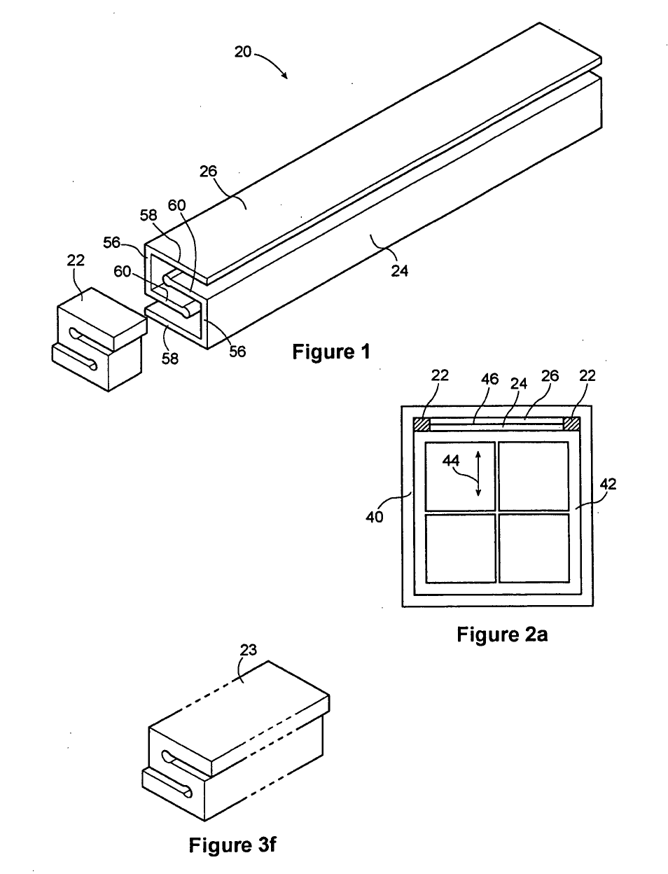

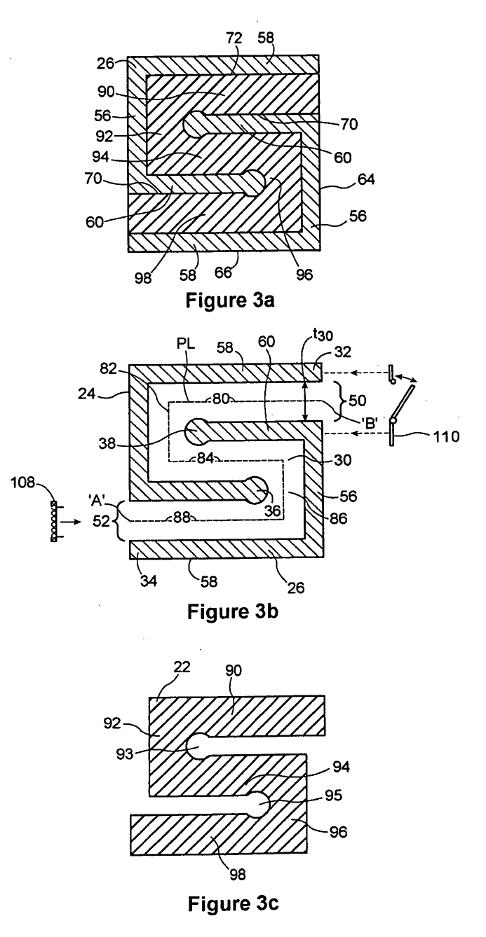

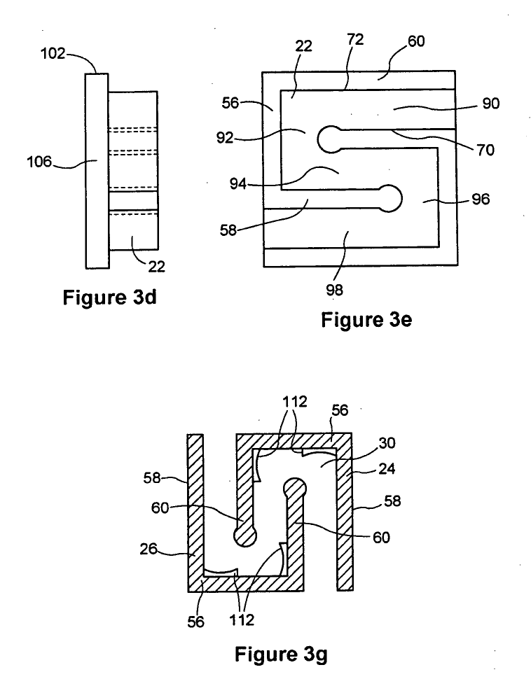

FIG. 1 shows the components of a modular vent assembly, indicated generally as 20. Vent assembly 20 may include one or more pieces in the nature of a first member 22, and a pair of first and second co-operating members 24, 26. First and second co-operating members 24, 26 may be members that, in use, are spaced apart from each other in a nested condition, as shown in FIG. 3b, such that a flow passageway 30 may be defined therebetween. It may be that vent assembly 20 includes an array of spacing governors, an integer of which array may be identified as a first member 22. In some embodiments, members 24, 26 and member 22 may be said to be elongate members having a constant cross-section in the direction of elongation. However many members 22 of this array there may be, they may be spaced along, and between members 24, 26 to hold members 24, 26 apart, and thereby maintain, or fix, the geometry of passage 30. It may be that members 24, 26 do not touch each other at any location. Members 24, 26 may have respective first and second ends 32, 34 and 36, 38. One member 22 may be located at the corresponding first ends 32, 34 of members 24, 26, and another member 22 may be located at the opposite, second ends 36,38. When so located, members 22 bound either side of passage 30. In so far as members 24, 26 may have a significant longitudinal extent, additional members 22 may be located in longitudinally spaced locations intermediate the first and second ends to maintain spacing, as may be required. Further, members 22 need not necessarily be located at the first and second ends. For example, the first and second ends may be capped, or closed, by an abutting flat plate, or by the upright members of a window or door frame.

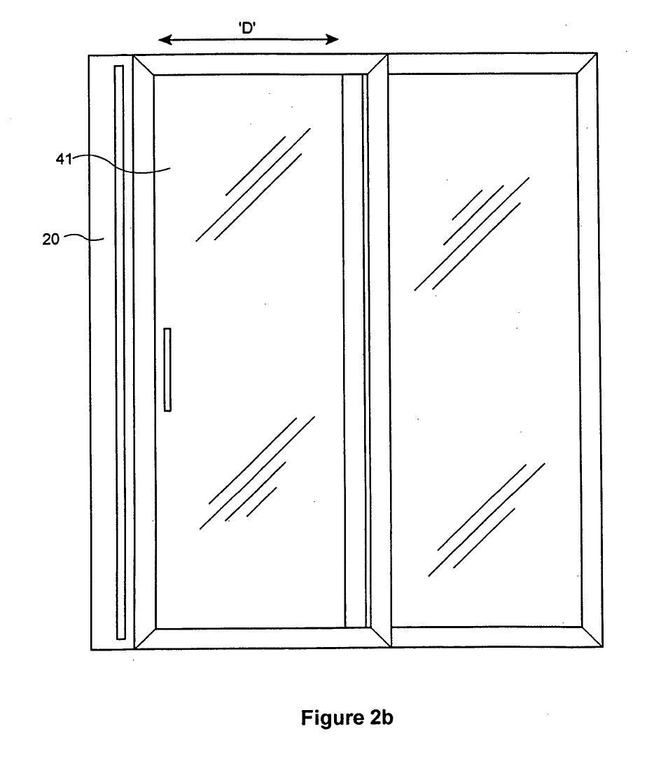

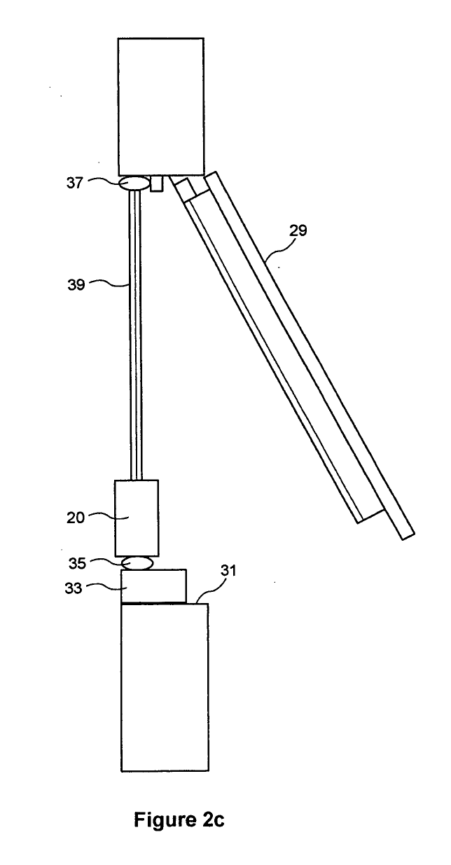

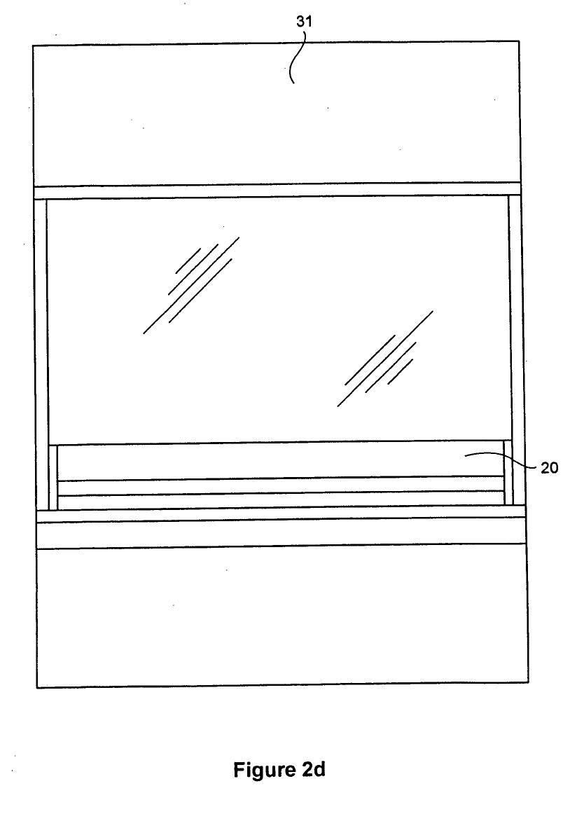

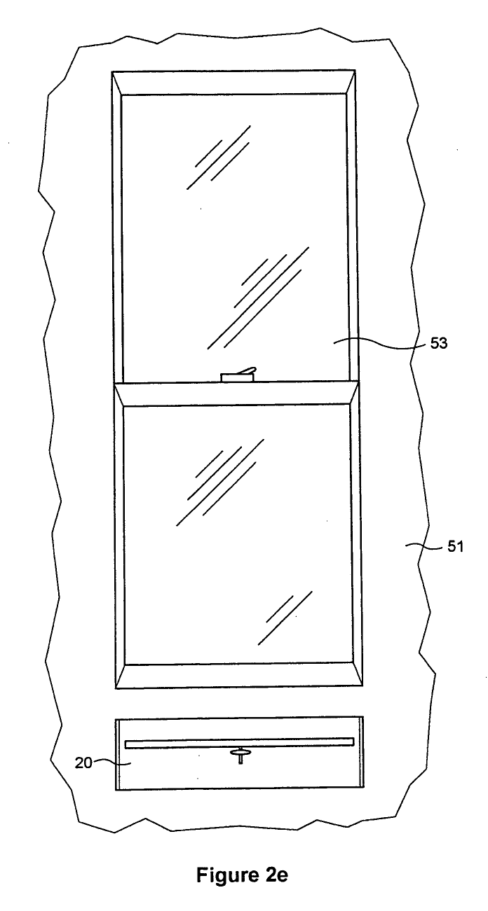

An installation of vent assembly 20 in a window mounting is shown in FIG. 2a. In FIG. 2a, a window frame 40 supports a vertically moveable window 42. Window 42 can slide up and down as indicated by arrow 44. In FIG. 2a window 42 is in its lowermost position, in which there is left a horizontally elongate opening 46. Vent assembly 20 is mounted in opening 46 between the frame members 24, 26, and two block members 22 (such as may have flat abutment ends for mating with ends 32, 34, and 36, 38, thereby to close the side ends of passageway 30, as suggested above. The position of the block members 22 is shown by single hatching at either end of the slot 46. It may be understood that when window 42 is closed, air may still pass through passage 30 such that there is fluid flow communication established from the exterior to the interior of the building by way of passage 30.

Other installations of vent assembly 20 are shown in FIGS. 2b, 2c, 2d, and 2e. In FIG. 2b, a vent assembly 20 is shown in a predominantly vertical orientation in a doorway next to a doorjamb. There is an adjacent door 41. Door 41 may be a sliding door, as suggested by Arrow ‘D’, and, in the closed position, the free edge of the sliding panel may be closest adjacent to the vent assembly. Although vent assembly 20 in this embodiment is illustrated as extending the full height of door 41, it could extend a portion of that height, in conjunction with a filler or spacer, or it could, extend a greater height depending on the lintel construction.

In FIGS. 2c and 2d, an embodiment of vent assembly 20 is mounted in a casement 31. A casement window 29 is pivotally mounted inwardly thereof. Vent assembly 20 forms part of a larger outer window assembly, not unlike a storm window assembly, that has a frame 33 having a sill fitting 35 and a lintel fitting 37. Vent assembly 20 is mounted to sill fitting 35. A translucent member 39 extend from vent assembly 20 to lintel fitting 37. Translucent member 39 may be a window pane and may be made of either glass, or perhaps more easily, plexiglass or other clear plastic, such that ventilation is only through passage 30, which may tend to be acoustically baffled.

In FIG. 2e, vent assembly 20 is mounted in a building wall 51 adjacent to, in this case below, but separate from, the window 53.

Passage 30 is of interest in this description. The geometry of passage 30 may be defined. First, the passage length, or passage arc length, PL may be taking as the linear measure along the mid-height plane, or path , or surface, mid-way between the facing walls of members 24, 26, from the entrance at 50 to the exit at 52. The width, W, of passageway 30 may be taken as the dimension extending into the page in FIGS. 3a, 3b, 3c and 3e, that is clear of members 22.

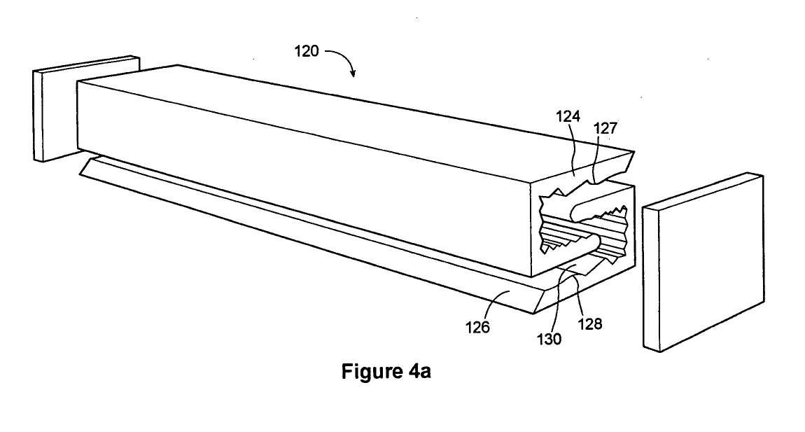

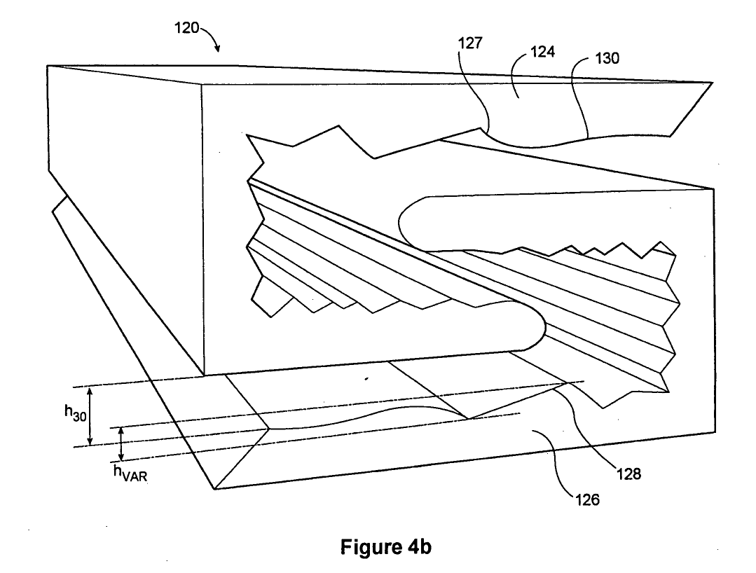

The depth, or thickness, of passageway 30 is indicated as t₃₀, and is the gap size of the spacing between the opposed walls. As will be apparent, passageway 30 need not be of constant depth or thickness, and may vary. As shown in the example of FIG. 4b, it may be that t₃₀ is an average depth or thickness, and that there is a measure of divergence, or variable depth, tᵥₐᵣ defining a range greater and lesser than the mean depth. As may be noted, passageway 30 may have a deviating nature, such that air flowing from the inlet at ‘A’ to the outlet at ‘B’ (the designation of “inlet” and “outlet” being somewhat arbitrary in those embodiments in which the vent assembly may be symmetrical and reversible, and in which the flow direction may reverse depending on whether the internal room pressure is greater or less than the prevailing external pressure).

It may be that in one or more embodiments, members 24 and 26 may be identical in section, and may be cut to length from linear extruded feed stock, or from cast stock, and placed in opposition to each other in symmetrical, 180 degree rotated positions relative to each other, with the spacing left between for the air gap, as indicated. That is to say, where the profiles are identical, and one part is reversed, either end for end or by rotation about the long axis of the part 180 degrees, the two fit together in a relationship of opposed symmetry, not as mirror images, but as rotated images. Passageway 30 may then also have a symmetry relative to its mid arc length position (i.e., the point at which the air may be said to be half way along its path from inlet ‘A’ to outlet ‘B’. Passageway 30 may have a labyrinthine nature, or may be in the form of a chicane, or S-shape, of reversing curves. It may be assumed in these examples that the width W of passageway 30 is much greater than the depth t₃₀ (typically more than an order of magnitude greater) such that rather than using hydraulic diameter (dₕ=4A/P, where A=passage cross-sectional area, and P=passage cross-sectional perimeter, either of which may be average values where the passage geometry may vary), the passage thickness may define a characteristic dimension for fluid flow or acoustic transmission purposes. It will be apparent that as the ratio of W:T₃₀ increases, the value of dₕ will approach 2t₃₀, in any event. The relationship of passage length to passage thickness may then provide a measure of both resistance to fluid (i.e., air) flow and of acoustic attenuation.

In each of the embodiments shown and described herein, there may be a relationship, or range of relationship between the characteristic thickness t₃₀ of passageway 30 (or such other passageway as may be identified in connection with any of the other embodiments shown or described herein) and its length L. For example, the ratio of L:t (be it L₃₀ and T₃₀, for example) may be in the range of greater than 8:1, and may be in the range of less than 24:1. In some embodiments, this ratio may be in the range of 8:1 to 20:1. In other embodiments it may be in the range of about 9:1 to 15:1, and in others it may be in the range of greater than about 10:1, and may lie in the range of about 10:1 to about 12:1.

There may be a range of acoustic frequencies for which attenuation along passageway 30 is desired. It may be that path length L of passageway 30 (or any of the other passageways described or shown herein) may be in the range of ¼ to 1 times the wavelength of the lowest design frequency for which attenuation is desired. For example, it may be that passageway 30 (or any other shown or described herein) may serve to attenuate acoustic waves in the range of 600 to 1200 Hz., or, perhaps more narrowly, 700 to 1000 Hz. (Standard temperatures and pressures being assumed on an ISA+15 (i.e., 15 C=59 F) day, at mean sea level (P_{ambient}=101.35 kPa=14.696 psia=760 mm Hg)). To that end, L may lie in the range of about 5 inches or more to about 20 to 25 inches, and may be in the narrower range of about 8 to 18 inches. The mean depth of passageway 30 may be of the order of 1/10 of the minimum wavelength, or less, and may be in the range of about 2% to about 6% of the minimum wavelength. In some embodiments that range may be between about ⅜ inches and about 2½ inches, or in the narrower range of about ¾ to 2 inches, and in some embodiments, about an inch, in other embodiments about 1¼ to about 1¾ inches.

Passageway 30 may have deviations in the nature of curves or bends, as indicated at ‘C’ and ‘D’. The angle of curvature of these curves by which the direction of flow is changed, summed together, may be in the range of 180 to 360 degrees. That is, where there are two 180 degree bends, even if opposite, the sum of those bends is 360 degrees. Where there are two 90 degree bends, the sum of those bends is 180 degrees. Where more than a single chicane is used, the angular sum of those bends may be greater, such as between 360 and 720 degrees.

One or both of members 24, 26 may have a substantially constant cross-section, such that either of members 24, 26 may be produced as an extrusion or linearly extending production process, such that lengths of uniform section may be produced and be cut to length as may be appropriate for the locus of installation. First and second members 24, 26 may have complementary nesting shapes. First member 24 may have the general form of a channel 54. Channel 54 may have a first wall portion identified as a back, or web, 56, and second and third wall portions identified as first and second legs 58, 60 extending away from opposite edges of web 56. Legs 58 and 60 may extend in substantially parallel planes, and may not necessarily be of equal length. One leg, leg 60, for example, may be shorter than the other. One leg, be it leg 60, may terminate in an enlarged end most distant from web 56. On assembly, one leg, be it leg 58, for example, may form an external wall of vent assembly 20 more generally. The other leg, be it leg 60, for example, may form an internal partition, wall, divider, or baffle, identified as item 62. Web 56 may also define an external wall of vent assembly 20. Channel 54 may be made of a substantially rigid material, be it a metal such as aluminum or steel, or a plastic, be it ABS or PVC, or a fibre filled reinforced resin composite, or a wood or wood-based (e.g., cellulose based) product.

In some embodiments, channel 54 may be made of a substantially rigid yet acoustically porous material, such as a substantially rigid foam. Channel 54 may be cast as a foam having a solid outer skin of relatively high density and modest thickness to yield at least modest strength or sturdiness, and a lower density internal lower density inwardly facing portion that may be relied upon less for strength than for sound deadening properties. Channel 54 may be manufactured as an extrusion, by forcing material through a die under pressure, or may be drawn through a die under tension. In some embodiments, channel 54 may be formed by a continuous casting process, which may or may not also be employed in conjunction with a rolling or roll forming process. The outside facing surfaces 64 and 66 of web 56 and leg 58, respectively, may be treated to have a desired external appearance, or may have a coating or cladding, whether by way of a painted, sprayed or dipped process, or may carry an external appearance member such as a glued or bonded on, or adhesive backed, transfer, band, ribbon or tape of material of a desired colour or design pattern. The inwardly facing surfaces 68, 70 of web 56 and leg 58 respectively may define wall of passageway 30. Leg 60 may have a first internal surface 72 tending to face toward the opposed internal face 70 of the other leg (when not assembled), and hence toward the opposed face 72 of leg 60 of member 26 when the parts are nested together. Similarly, the other face 74 of leg 60, which would otherwise be and outwardly facing surface, is an inwardly facing surface that, when assembled is opposed to inwardly facing surface 70 of leg 58 of member 26, those two surfaces defining, for example, an intake or upstream portion of passageway 30, and, similarly, surface 72 of leg 60 of member 26 and surface 70 of leg 58 of member 24 cooperating to define an outlet or downstream portion of passageway 30.

As noted above, spacing between members 24 and 26 is maintained by spacing governors identified as members 22. The cross-section of member 22 is substantially the same as the cross-section of passageway 30. That is, in one embodiment passageway 30 has a first portion, which may be termed the inlet portion, or reach, identified as 80, a first bend region 82, a middle portion 84, a second bend portion 86, and an outlet leg or portion 88. Similarly and correspondingly, member 22 may have, in one embodiment, a first portion, which may be termed the inlet portion 90, a first bend region 92, a middle portion 94, a second bend portion 96, and an outlet leg or portion 98. Reliefs 93 and 95 may be formed in member 22 that correspond to legs 60 of members 24 and 26, respectively. Those reliefs 93,95 may, in whole or in part, be slightly smaller than legs 60, such that, on installation, an interference fit condition is achieved. Alternatively, either (a) an attachment agent, such as a glue, an epoxy, or a bonding agent; or (b) fastening hardware, such as screws, expanding shank plugs, nails, blind rivets (“pop rivets”) or the like may be employed to fix the axial location of members 22 along members 24 and 26.

It may be that there are first and second end members 22, being identified as end caps 102 and 104 respectively. These end members may be cut or otherwise formed to the desired profile, and then seated snugly between members 24, 26. In some embodiments these end caps 102 may be seated flush with the ends of members 24, 26. In other embodiments, end caps 102 may be mounted on, or may be formed as part of, end cap plates 106, such that the resulting profiled portions thereof act as male plugs that may tend to seat in the female sockets defining the passageway gap between members 24, and 26. Plates 106 extend in some part peripherally beyond members 102 and 104, and have marginal shoulders, or abutments, or lands, that seat against (i.e., abut) the end faces of members 24, 26. It may be that members 22 in general, and items 102, 104 in particular may be somewhat oversized, such that when installed they fit in a modest interference fit between items 24 and 26. This squeezing interference fit may tend also to form a seal at the end, or sides, as they may be termed, of passageway 30. Given that sound attenuation may vary as a function of gap width, members 22 of vent assembly 20 may be such as to maintain a fixed design gap spacing for the range of frequencies and degree of attenuation for which vent assembly is designed. This may be seen in contrast to labyrinthine or chicane devices whose gap width can be altered, as, for example, by raising or lowering a sash.

An interference fit piece may be held in place by the mutually interlocking shapes of the longitudinally extending members and, for example, an indexing feature, which function may be served by the bulbous nature of the termination of leg 60. That is, it may be that members 22 can be installed by sliding them into place along the longitudinally extending members, by linear translation in a direction of a first, linear degree of freedom, that linear degree of freedom being translation parallel to the long direction of members 24 and 26.

Alternatively, to the extent that members 22 are made of a resilient material, and to the extent that reliefs 93, 95 may be slightly undersize to achieve a final interference fit on installation, members 22 may in some embodiments be snap fit into place by, first, locating them axially along either of member 24 and 26, and then, second, by driving them transversely toward the back of the channel (e.g., in one embodiment, that is, normal to web 56, parallel to leg 60). The parts may be deflected on installation and spring back when the bulbous end (or such other detent feature as may be) of leg 60 seats in the corresponding bulbous end 97 of relief 93 (or 95, as may be) and is thereby engaged in the manner of a detent fitting. The other of members 24, 26 may then be placed in a corresponding axial position, and the two parts driven transversely together, and being held by the interlocking shape, and the common detents. It may be that the second and third steps may take place at the same time, in one snap-fit engagement step.

Expressed somewhat differently, in one embodiment, the configurations of the elongate frame members 24 and 26 may be such as to leave, between the frame members 26 and 28, passageway 30, which may be S-shaped. As noted, the passageway closely conforms in profile to the profile of the cross-section of the block member, namely spacing governor member 22. It can also be imagined that the opposition of the first and second portions, i.e., legs 58 and 60, of each frame member 24, 26 is such as to grip or squeeze the contained portion of the block member 22, which in turn passes along the squeezing or gripping action to the “second portion”, namely the shorter leg 60, of the other elongate frame member 26. This mutual squeezing or pinching action exerted by the elongate frame members 24, 26 may, in effect, keep the entire unit together (once assembled) without requiring special fasteners, outer jackets, and so on.

By equipping the “second portion”, namely shorter leg 60, of each frame member 24, 26 at the inner end with a bead, such as bulbous end 55, the latter matching a corresponding cylindrical chamber or bulge in the form of bulbous end 97 in the corresponding slot, be it relief 95, or 95, a firm engagement of all three structural members is attained. When the block member 22 is installed within the elongate frame members 24, 26, the result is as shown in FIG. 3a. A bulbous beads, such as item 55, and a corresponding enlarged recesses, such as item 93, do not represent the only configurational irregularity that could be employed as indexing or retaining members used to make the components resist disassembly. In some embodiments, block member 22 and elongate frame members 24, 26 may be composed of sound-absorbent material, such as felt or any commonly utilized cellular plastic. When assembled, vent assembly 20 may tend to have a generally box-like shape, with a four-sided generally rectangular of square section, in which top wall are defined by legs 58 of members 24, 26 and front and rear walls are defined by the back members, i.e., webs 56 of members 24, 26, with longitudinally running slot openings at 50, 52 between the distal tip of legs 58 and the nearest vertex of the respective web 56 of the other structural member 24 or 26, as may be.

It may also be that, optionally, vent assembly 20 may have apparatus mounted at inlet ‘A’ (or possibly elsewhere) such as may tend to exclude undesirable entrants. For example, there may be a grill or screen 108 mounted athwart entrance ‘A’ to discourage admission of insects, dirt, dust, or other unwanted objects. It may also be that vent assembly 20 may include a flow governor, such as may be in the nature of a closure member 110. Closure member 110 may include one or move slats which may, for example, be slidably or pivotably movable between an open position and a closed position to obstruct passageway 30 as at ‘B’, to a greater or lesser extent. Vent assembly 20 may be mounted in a fixed position, whether mounted to a bracket, a sill, a doorjamb, or other suitable location. Alternatively, vent assembly 20 may be mounted in a movable condition, such that it may be turned (e.g., rotated about its long axis) such that either the entrance of the exit of passageway 30 is facing a panel, be it the window sill or some other wall, such that flow through passage 30 is obstructed or prevented in whole or in part.

The elements of vent assembly 20 may be supplied as a kit. The kit may include members 24 and 26, which may be supplied as a matching pair of co-operably opposable longitudinally extending members. The closure members may be provided at a pre-cut length specific to the desired application, or they may be provided at a generic stock length for subsequent trimming to length. Such a kit may also include a pair of spacing governors such as may be in the form of items 22, and, as so employed, those spacing governors may be termed end caps, whether with or without backing plates 106. It may also include one or more additional spacing governors for intermediate placement along the longitudinally extending members between the end caps. The kit may also include a closure member movable between closed an open positions. The closure member may be pre-assembled to one or the other of members 24 or 26. The kit may include a filtering or screening member. The filtering or screening member may be provided pre-assembled to one or the other of members 24 or 26. The kit may further include one or more cosmetic appearance members, such as may be in the nature of cover plates, or trim panels, or adhesive backed transfers, or the like, such as may be applied to one or more externally facing surfaces of vent assembly 20. The elements of vent assembly may be washable, and may be capable of disassembly to permit washing.

FIG. 1, is an exploded view of three components, showing them in alignment, as if the elongate frame members 24 and 26 were positioned in final configuration, prior to insertion of a block member from one end. While this might be a feasible method, it is expected that the block member 22 would be engaged sequentially with the frame members 24, 26, merely to avoid the necessity of keeping three components at a time in spatial alignment.

In one simple embodiment, a simple practical juxtaposition of the components making up vent assembly 20 may have just the two elongate frame members 24 and 26, and two identical block members 22. The block members 22 may be engaged with the extremities of the frame members 24, 26, to cap the ends of the space between those members, and thereby to define side walls of the passageway.

FIG. 3f illustrates a variable length for an alternate block member 23. This item may be marketed with two frame members 24, 26, and a number of block members 22, so that air and sound passageway 30 between the frame members could be blocked up or occluded to a greater or lesser extent, by selecting some but not others of the block members, which would be placed at intermediate positions between the ends of the elongate frame members. Thus, instead of a single S-shaped passageway for air, there would be several passageways whose combined length is less than that of the main embodiment discussed previously (the one with only two block members, positioned at either end).

In addition to the variable characteristics offered by providing two or more block members of different lengths (or which could be cut to form even more block members), there is the possibility of rotating the entire baffle so that, for example, the opening which is identified at either inlet ‘A’ or outlet ‘B’ may be closed off by the upper part of the window frame, and the other opening would be blocked off by the window itself.

In the embodiment of FIG. 3g, the second and third components 24, 26 are seen in section, and in their final mutual orientation. Secured to the inside surfaces defining the S-like passageway 30 are a plurality of reflective units 112, aimed so as to reflect sound waves back in the direction of their source, that source being assumed to be at entrance opening ‘A’. As noted elsewhere, air in passageway 30 may flow in either direction depending on the relative internal and external ambient pressures at ‘A’ and ‘B’.

In the embodiment of FIG. 4a, there is a vent assembly 120. For the purpose of avoidance of redundant description, except as otherwise described hereinbelow, vent assembly 120 may tend to have all of the features and attributes and alternative embodiments that pertain to vent assembly 20, including spacing governors 122 having profiles mating with the profiles of the longitudinally extending members 124, 126, may have a closure member, and may have a screen or vent, and so on.

Vent assembly 120 may tend to differ from vent assembly 20 insofar as longitudinally extending members 124 and 126 have inwardly facing surfaces 127, 128, that are not generally flat, but rather are broken up, with variations and undulations, peaks and valleys. Surfaces 127, 128 are uneven, such that passageway 130 is of varying depth. That is, a characteristic dimension of passageway 130, the depth, h₁₃₀ may have two components, those components being a mean depth hₘₑₐₙ and a variable portion of depth, h_{variable} within a certain range. It may also be that in addition to a passage depth or thickness, the walls may have a characteristic depth or thickness, which, again, may have a mean value and may have a component of variation falling within a range. The mean depth may tend to be in the range of ½ to 1½ inches, or more narrowly, between ¾ and 1¼ inches. The variation in depth may be in the range of ¼ to ¾ inches from peak to valley (or, half that, perhaps, from the mean to the peak or from the mean to the bottom of the valley). The pattern of features may be regular, or irregular, both in terms of spacing between features, i.e., pitch spacing along the direction of flow in passageway 130, and in terms of the amplitude of the features. It is believed that a pattern of undulations, or interruptions may tend to promote attenuations of sound to some extent.

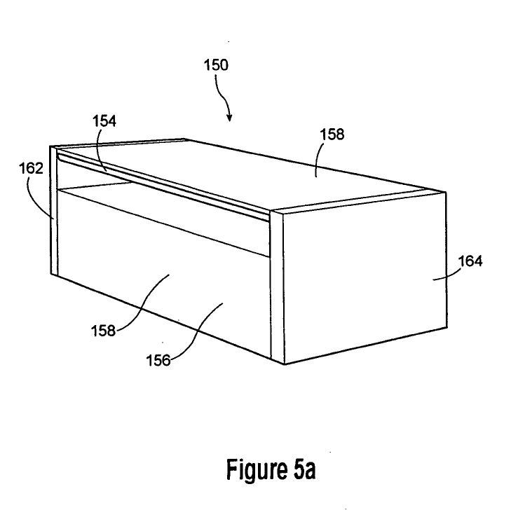

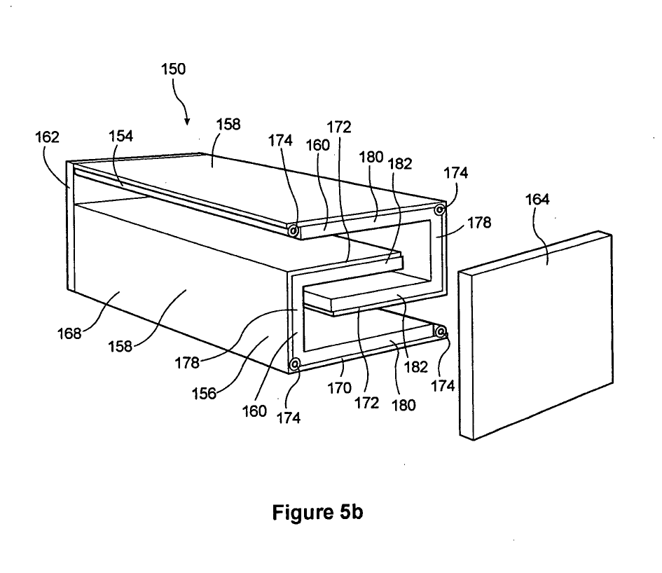

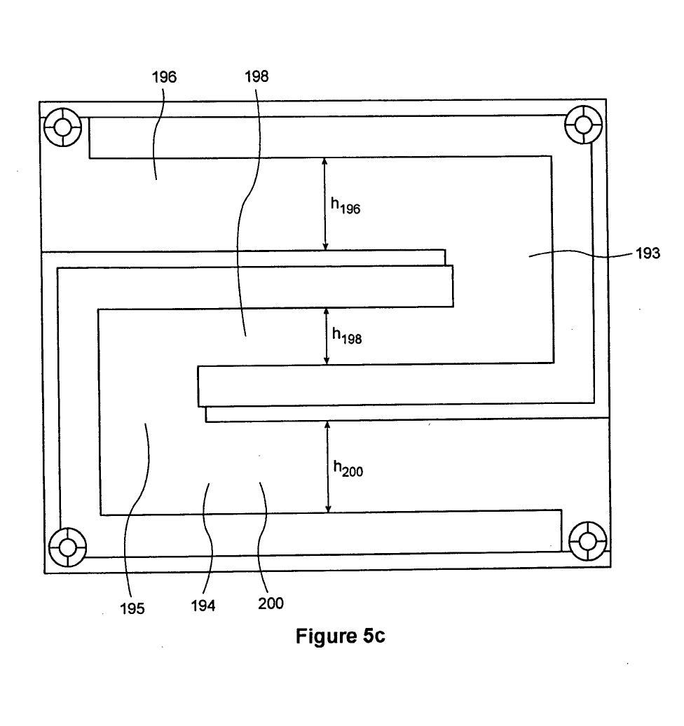

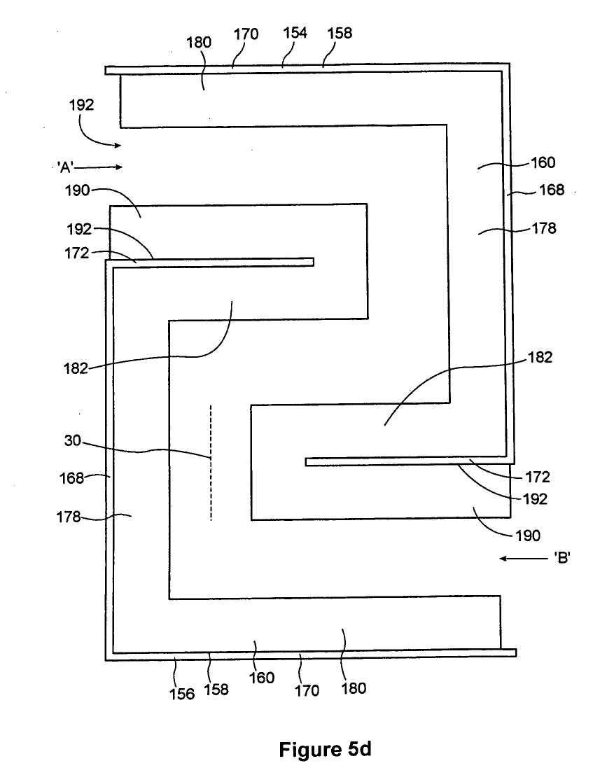

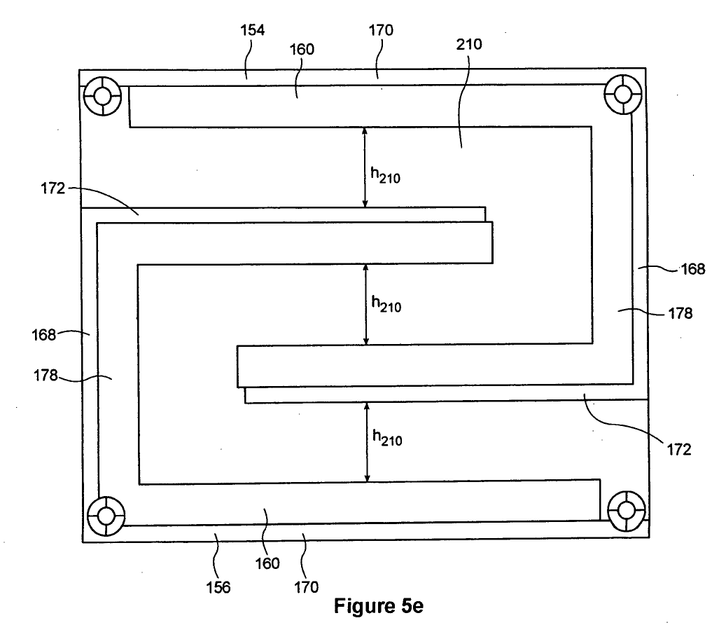

In the embodiment of FIG. 5a there is a vent assembly 150. For the purpose of avoiding redundant description, vent assembly 150 may tend, generally, to be the same as vent assembly 20 and vent assembly 120. However, vent assembly 150 may include first and second longitudinally extending, co-operable opposable members 154, 156 that include a hard exoskeleteal member, or portion 158 and one or more passage wall liners, or wall lining elements, 160. Members 154, 156 may tend to provide the structural rigidity of vent assembly 150 generally, and may be closed at their associated first and second axial ends by end caps 162, 164. Each of structural members 154, 156 may have the general form of a channel section, each having a back, or web 168, a first, or outside leg 170, and a second, or inside, leg 172. Leg 172 may be shorter than leg 170. Members 154 and 156 may be of identical section, and, when one is reversed end-for-end, or rotated 180 degrees about the long axis, the two parts nest in substantially the same manner as described above. Members 154, 156 may have end cap locating fittings 176, which may in turn co-operate with mating fittings of end caps 162, 164 on assembly to yield the assembled object.

Wall lining elements 160 may be acoustic absorption elements. Wall lining elements 160 may be shaped to have a generally channel shaped cross-section, having a back 178, an outside leg 180, and an inside leg 182, which nest, or seat, in mating engagement within the channel shape of member 154 of member 156 as may be, seating, respectively, against the inside faces of back 168, first leg 170, and second leg 172. It may be that the component members of wall lining elements are formed as a monolithic channel shaped member, or it may be that the individual components 178, 180 and 182 are applied as substantially planar strips, that, when installed, conform to the profile of the structural skeletal member, which, in one embodiment, is a channel shape. Alternatively, lining elements 160 may be formed in place, with members 154 and 156, or the feedstocks from which they are made, before being cut to length, forming the outside of a mold, or form, into which the material of wall liner element 160 is made. The exposed faces of the portions 178, 180 and 182 of wall liner element 160 may be formed against a form that is removed after fabrication. Alternatively, in embodiments in which wall liner element 160 is formed separately, and then mated with members 154 and 156, wall liner element 160 may be held in place by an interference fit, by attachment fittings, or by an adhesive attachment, whether by glue, epoxy, or a bonding agent.

As shown in FIG. 5d, it may be that a wall liner element 190 is also mounted to the outside, or other side, 192 of the internal leg 172, such as to face toward portion 178 of the opposed skeletal member, be it 154 or 156.

In the embodiment of FIG. 5c, passageway 194 has an inlet portion 196, a first turn 193, a second, or middle portion 198, a second turn 195, and an outlet portion 200. Outlet portion 200 and inlet portion 196 may have different gap widths h₂₀₀, h₁₉₆ from the middle portion, h₁₉₈. For example, gap width h₂₀₀ may be the same as gap width h₁₉₆, both being larger than gap width h₁₉₈.

It may be that a more nearly constant mean gap width is desired. This may be achieved either by providing wall lining on both sides of all three portions (196, 198, 200) as in FIG. 5d, or by adjusting the end cap and intermediate spacing governor members (if any are used) to give the spacing shown in FIG. 5e, in which all of the mean gap widths h₂₁₀ in the inlet, middle, and outlet legs (202, 204, 206) of the passageway 210 are substantially the same.

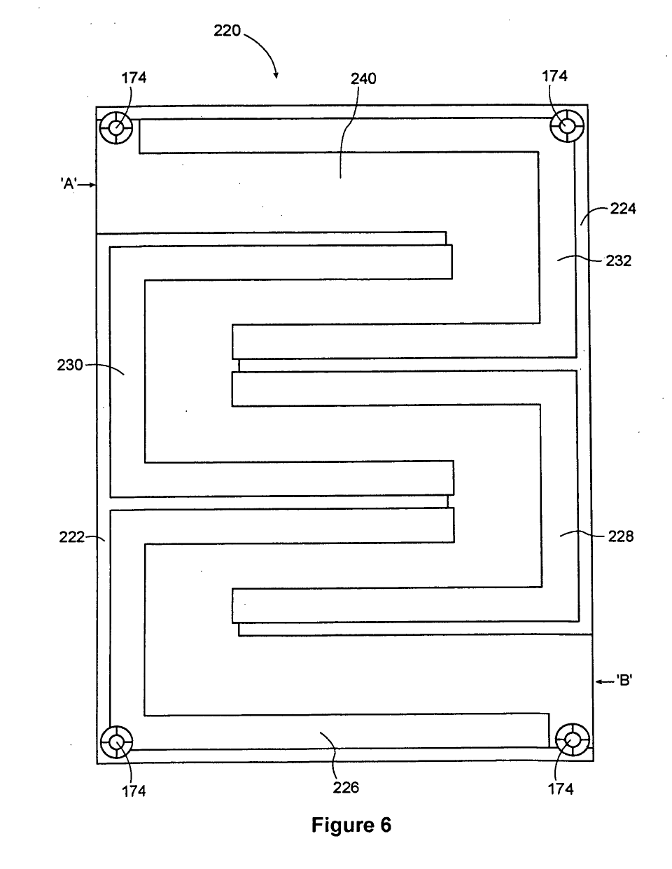

In FIG. 6, a vent assembly 220 has a nested arrangement of longitudinally extending structural members 222, 224, such as may be aluminum of plastic extrusions, for example, that are provided with internally nested lining members 226, 228, 230, 232. Vent assembly 220 is substantially the same as vent assembly 20, 120, or 150 in terms of general structure and properties, but differs to the extent that it has a greater number of flow direction reversals. That is to say, the shape of the flow passage 240, need not be limited to a single s-shaped bend of two flow direction reversals, but may have a greater number of bends.

As before, the two halves may be substantially identical, may be manufactured as linearly running stock that may be cut to length later. The lining material may be sound deadening or sound absorbing material, and may be cast in place, or may be attached by mechanical fasteners or by an adhesive such as a glue, an epoxy, or a bonding agent, as may be suitable.

In each embodiment described hereinabove, the vent assembly may tend to allow a flow of air from one side of the unit to the other side of the unit while tending to attenuate sound. The unit may be mounted in a horizontal installation, such as in a window frame, or transom, or clerestory location, or may be installed in a vertical installation, such as adjacent to a door panel. The use of two parts having the same shape, oriented to oppose and engage each other, may tend to facilitate manufacture, assembly and installation. The use in some embodiments of skeletal members providing structural strength or sturdiness, with liner members such as may tend to be less rigid, and such as may tend to provide a measure of sound deadening.

Various embodiments of the invention have been described in detail. Since changes in and or additions to the above-described best mode may be made without departing from the nature, spirit or scope of the invention, the invention is not to be limited to those details but only by the appended claims.

I claim:

1. A vent, said vent comprising:
first and second longitudinally extending members;
an array of spacing governors;
said first and second members being mutually locatable in opposition to each other to define an air passageway therebetween, to permit airflow between said first and second members in a direction cross-wise relative to their longitudinal extent;
said spacing governors being mounted to retain said first and second members in a fixed position relative to each other;
said air passageway having deviations, said deviations having angles, a sum of said angles being at least as great as 180 degrees; and
said air passageway having an inlet, an outlet, a path length measured between said inlet and said outlet, and a mean path depth between said first and second members cross-wise to said path length; and
said path length being at least 8 times as great as said mean path depth.

2. The vent of claim 1 in the form of a kit prior to assembly.

3. The vent of claim 1 wherein said first and second members have the same cross-sectional profile.

4. The vent of claim 1 wherein said first and second members are substantially the same.

5. The vent of claim 1 wherein said vent has a screen mounted thereto athwart said air passageway.

6. The vent of claim 1 wherein said vent has a closure member mounted thereto, said closure member being movable to a position impeding flow through said air passageway.

7. The vent of claim 1 wherein at least one of said first and second members includes a lining mounted to a substantially rigid member.

8. The vent of claim 7 wherein said first and second members are channel members and acoustic linings are mounted inside said channel members.

9. The vent of claim 8 wherein said channel members have the same cross-section, and each channel section has one leg shorter than another.

10. The vent of claim 1 wherein:
said first and second longitudinally extending members are structural sections, said structural sections having substantially the same cross-sectional profile, and said structural sections each having a back, a first leg and a second leg, the first and second legs extending away from said back, said second leg being shorter than said first leg;
said first and second members, when assembled, being positioned with said second leg of said first longitudinally extending member being located between said first and second legs of said second longitudinally extending member, and said second leg of said second longitudinally extending member being located between said first and second legs of said first longitudinally extending member;
said first and second longitudinally extending members having respective first and second ends;
said array of spacing governors including a first end cap and a second end cap;
said first end cap being mountable to said first ends of said first and second members and defining a side wall of said passageway;
said second end cap being mountable to said second ends of said first and second longitudinally extending members;
said air passageway having at least one pair of reverse bends;
at least one of said first and second members includes an acoustic attenuation lining mounted to a substantially rigid member.

11. The vent of claim 10 wherein each of said structural sections is a channel section, and each of said channel sections has a sound deadening lining mounted to each of said back, said first leg, and said second leg.

12. The vent of claim 10 wherein each of said structural sections is a channel section, and each of said channel sections has a sound deadening lining mounted therein, each of said linings itself being channel shaped to seat within its respective channel.

13. The vent of claim 12 wherein said sound deadening linings are fabricated within said channel sections, and said channel sections define at least a portion of a containment form during the fabrication of said sound deadening linings.

14. The vent of claim 10 in the form of an unassembled kit.

15. The vent of claim 10 wherein said passageway defined between said first and second structural members has an intake portion, a first bend, a middle portion, a second bend, and an outlet portion, and said passage.

16. A vent, said vent comprising:
a pair of first and second longitudinally extending channel sections of substantially the same cross-sectional profile, each of said channel sections having first and second ends;
said first and second channel sections being mutually locatable to define a tortuous air passageway therebetween;
a pair of first and second spacing fittings, on assembly being co-operable with said first and second channel members to maintain said first and second channel members in a fixed, spaced apart condition;
said first spacing fitting being engageable with said first ends of said first and second longitudinally extending channel sections;
said second spacing fitting being engageable with said second ends of said longitudinally extending channel sections;
sound deadening lining, said sound deadening lining being mountable within said channel sections along said passageway;
when said vent is assembled, said passageway including an inlet, a first portion, a first bend, a second portion, a second bend, a third portion and an outlet;
said first bend having an angle of at least 90 degrees;
said second bend having an angle of at least 90 degrees;
said first and second bends defining a reversing chicane;
said passageway having a path length L;
said passageway having a mean passage depth, h,
said path length L being at least 8 times as great as said mean passage depth, h.

17. The vent of claim 16 wherein said channel sections each have a long leg and a short leg, and, when assembled, said short leg of said first channel section nests between said long leg and said short leg of said second channel section, and said short leg of said second channel section nests between said long leg and said short leg of said first channel section.

18. The vent of claim 16 wherein said vent is supplied in a kit form for assembly by a purchaser.

19. A combination of the vent of claim 16 and a window, said vent being mounted with said channels in a predominantly horizontal orientation.

20. A combination of the vent of claim 16 and a doorway, said vent being mounted adjacent to a door, and said channels being oriented in a predominantly upstanding orientation.
